(19) United States
(12) Patent Application Publication
(10) Pub. No.: US 2013/0327415 A1
(43) Pub. Date: Dec. 12, 2013

(54) COUPLING MECHANISM

(71) Applicants: William Paul Camp, JR., Vanlue, OH (US); Owen Michael Atchison, Findlay, OH (US)

(72) Inventors: William Paul Camp, JR., Vanlue, OH (US); Owen Michael Atchison, Findlay, OH (US)

(21) Appl. No.: 13/494,542

(22) Filed: Jun. 12, 2012

(51) Int. Cl. F16L 41/02; F16L 47/32

(52) U.S. Cl. 137/15.09; 137/798; 285/133.11

(57) ABSTRACT

Coupling mechanisms for connecting a plurality of pipes are provided. The coupling mechanisms may include a first portion including a first wall having a substantially arcuate cross-sectional shape and defining a first channel, a second portion including a second wall having a substantially arcuate cross-sectional shape and defining a second channel, and a hinge portion connecting together the first portion and the second portion. The first portion and second portion may be configured to pivot about the hinge portion. In an open configuration of a coupling mechanism, the first portion may be laterally adjacent to the second portion. In a closed configuration of a coupling mechanism, the first portion and the second portion may be folded together about the hinge portion to form a first lumen encased by the first wall and the second wall.

### FIELD OF THE DISCLOSURE

Embodiments of the present disclosure include coupling mechanisms for connecting together a plurality of pipes, and more particularly, coupling mechanisms including first and second portions configured to fold together about a hinge portion.

### BACKGROUND OF THE DISCLOSURE

Generally, corrugated pipe or tubing may be employed for a number of domestic, agricultural, and industrial drainage applications. The pipe may be connected to other pipes and/or cut into shorter lengths for meeting certain installation needs.

When installing a system of pipes for drainage purposes, the ends of two or more pipes may be connected together. A variety of couplings or joints may be utilized in connecting together such pipe ends. For example, certain external coupling mechanisms may comprise a tubular structure including a lumen extending therethrough. The pipe ends may be inserted into the lumen of the tubular structure, and the tubular structure may surround an outer surface of each pipe. In other applications, certain internal coupling mechanisms may be employed. The internal coupling mechanism may include a tubular structure coupled to the end of a first pipe and having one or more lugs positioned around an outer surface of the tubular structure. The tubular structure may be inserted into an open end of a second pipe, and the lug may engage with, for example, a corrugation valley defined on an internal surface of the second pipe.

Such coupling mechanisms, however, include limitations. For example, the tubular structures of external coupling mechanisms generally are closed, hollow objects. As such, when packaging the external coupling mechanisms, the tubular structures occupy a generally large volume, which inhibits the number of external coupling mechanisms that may be shipped and/or stored. Moreover, for pipe systems utilizing internal coupling mechanisms, a first pipe including the tubular structure of the internal coupling mechanism requires a longer length to accommodate the insertion of the tubular structure into a second pipe.

Accordingly, the coupling mechanism of the present disclosure is directed to improvements in the existing technology.

### SUMMARY OF THE DISCLOSURE

In accordance with an embodiment, a coupling mechanism for connecting together a plurality of pipes may include a first portion including a first wall having a substantially arcuate cross-sectional shape and defining a first channel, a second portion including a second wall having a substantially arcuate cross-sectional shape and defining a second channel, and a hinge portion connecting together the first portion and the second portion. The first portion and the second portion may be configured to pivot about the hinge portion. In an open configuration of the coupling mechanism, the first portion may be laterally adjacent to the second portion. In a closed configuration of the coupling mechanism, the first portion and the second portion may be folded together about the hinge portion to form a first lumen encased by the first wall and the second wall.

In accordance with another embodiment, a method for connecting together a plurality of pipes may include positioning a coupling mechanism in an open configuration. The coupling mechanism may include a first portion including a first wall having a substantially arcuate cross-sectional shape and defining a first channel, a second portion including a second wall having a substantially arcuate cross-sectional shape and defining a second channel, and a hinge portion connecting together the first portion and the second portion, wherein the first portion and the second portion may be configured to pivot about the hinge portion. In the open configuration, the first portion may be laterally adjacent to the second portion. The method may further include positioning a first pipe in the first channel of the first portion at a first end of the first channel, positioning a second pipe in the first channel of the first portion at a second end of the first channel opposite the first end, and folding together the first portion and the second portion about the hinge portion to encase the first pipe and the second pipe with the first wall and the second wall.

In accordance with yet another embodiment, a pipe system may include a plurality of pipes and a coupling mechanism configured to fluidly connect together the plurality of pipes. The coupling mechanism may include a first portion including a first wall having a substantially arcuate cross-sectional shape and defining a first channel, a second portion including a second wall having a substantially arcuate cross-sectional shape and defining a second channel, a hinge portion connecting together the first portion and the second portion, wherein the first portion and the second portion may be configured to pivot about the hinge portion, and a lock mechanism coupled to the first portion and the second portion. The first portion and the second portion may be folded together about the hinge portion to encase open ends of the plurality of pipes with the first wall and the second wall. A key mechanism may be engaged with the lock mechanism to secure together the first portion and the second portion.

In this respect, before explaining at least one embodiment of the present disclosure in detail, it is to be understood that the present disclosure is not limited in its application to the details of construction and to the arrangements of the components set forth in the following description or illustrated in the drawings. The present disclosure is capable of embodiments in addition to those described and of being practiced and carried out in various ways. Also, it is to be understood that the phraseology and terminology employed herein, as well as the abstract, are for the purpose of description and should not be regarded as limiting.

The accompanying drawings illustrate certain exemplary embodiments of the present disclosure, and together with the description, serve to explain the principles of the present disclosure.

As such, those skilled in the art will appreciate that the conception upon which this disclosure is based may readily be used as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

FIG. 1 is a schematic illustration of a pipe system, according to an exemplary disclosed embodiment;

FIG. 2 illustrates a perspective view of a coupling mechanism in an open configuration, according to an exemplary disclosed embodiment;

FIG. 3 illustrates another perspective view of a coupling mechanism in an open configuration, according to an exemplary disclosed embodiment;

FIG. 4 illustrates a perspective view of a coupling mechanism in a closed configuration, according to an exemplary disclosed embodiment;

FIG. 5 illustrates another perspective view of a coupling mechanism in a closed configuration, according to an exemplary disclosed embodiment;

FIG. 6 illustrates a perspective view of a key mechanism for a coupling mechanism, according to an exemplary disclosed embodiment;

FIG. 7 illustrates a perspective view of a pipe system having a coupling mechanism in an open configuration, according to an exemplary disclosed embodiment; and

FIG. 8 illustrates a perspective view of another coupling mechanism in an open configuration, according to an exemplary disclosed embodiment.

### DETAILED DESCRIPTION

Reference will now be made in detail to exemplary embodiments of the present disclosure described above and illustrated in the accompanying drawings. Wherever possible, the same reference numbers will be used throughout the drawings to refer to the same or like parts.

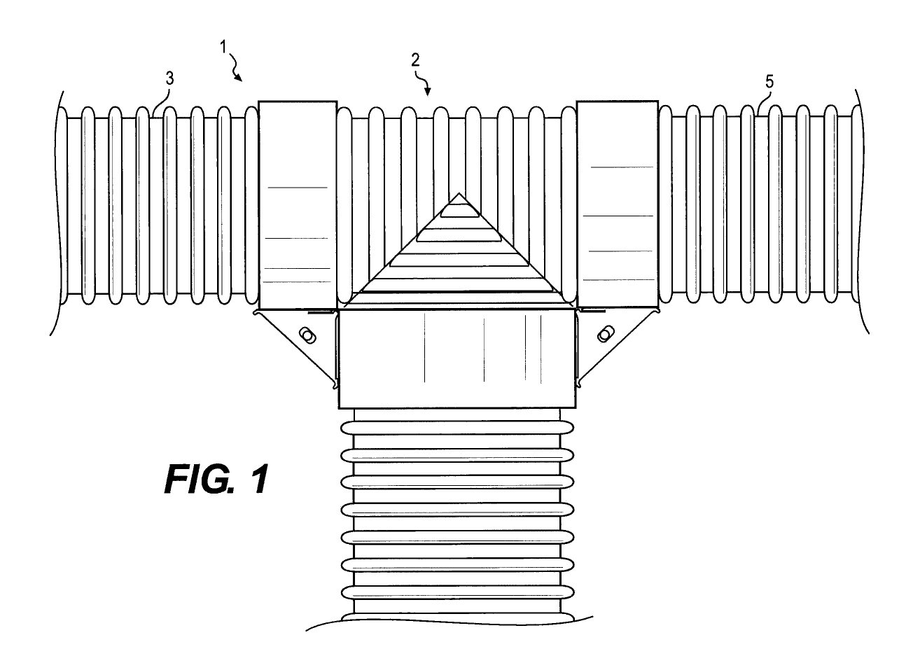

FIG. 1 illustrates a schematic view of an exemplary pipe system 1 of the present disclosure. Pipe system 1 may be configured to collect, transport, and drain a fluid to an appropriate location. In one embodiment, pipe system 1 may be a subterranean drainage system disposed below a surface of a ground, such as a road, sidewalk, or lot, and may be employed to drain excess rain or groundwater from the ground to an appropriate discharge point, such as a canal, river, lake, ocean, or treatment facility (not shown). It should be appreciated, however, that the details of the disclosed pipe system will be applicable in various other drainage settings. For example, pipe system 1 may be utilized in mining, agriculture, sewage disposal, a storm sewer, a turf or recreational field, the timber industry, landfill and waste disposal, road and highway drainage, and residential and commercial drainage applications for transporting and draining various types of fluid.

Pipe system 1 may include one or more pipes coupled together by a coupling mechanism 2. In the exemplary embodiment of FIG. 1, coupling mechanism 2 may be configured to fluidly connect together a first pipe 3, a second pipe 4, and a third pipe 5. It should be appreciated, however, that pipe system 1 may include any number of pipes connected together by coupling mechanism 2. Accordingly, fluid, such as, for example, rain water, may be transported from one or more of first pipe 3, second pipe 4, and third pipe 5, through coupling mechanism 2, and to the other of first pipe 3, second pipe 4, and third pipe 5. Discharged fluid then may be transported and drained to an appropriate discharge point.

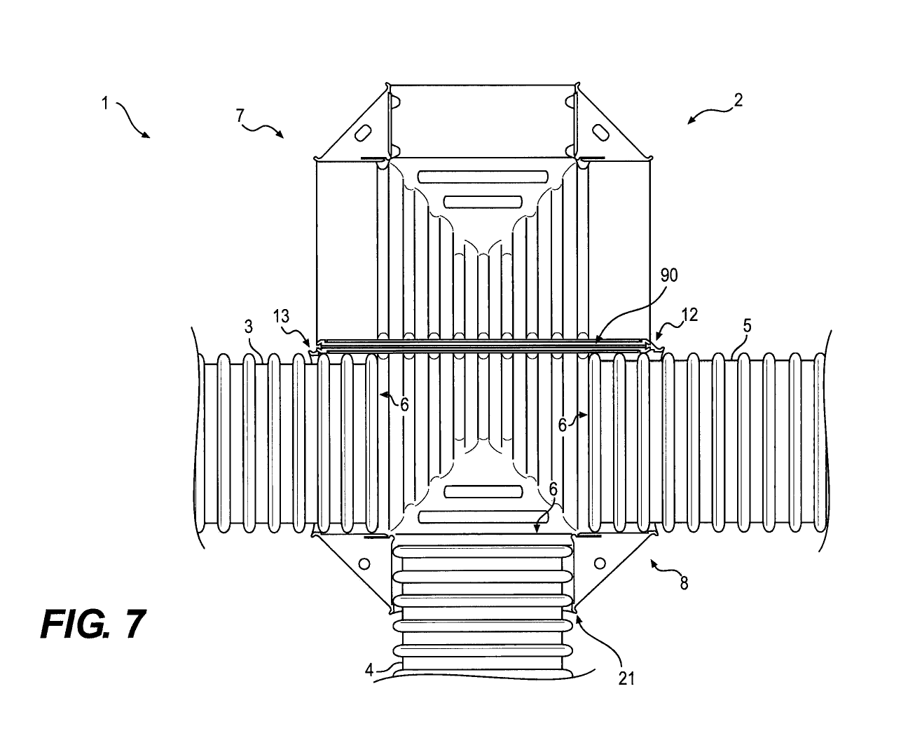

Pipes 3, 4, 5 may be corrugated, high density polyethylene pipes (HDPE). In other embodiments, pipes 3, 4, 5 may have smooth outer surfaces or ribbed outer surfaces, and may be formed from any other appropriate material, such as, for example, polyvinylchloride (PVC). Each of pipes 3, 4, 5 may include an open end 6 (FIG. 7) in fluid communication with each other and coupled together by coupling mechanism 2.

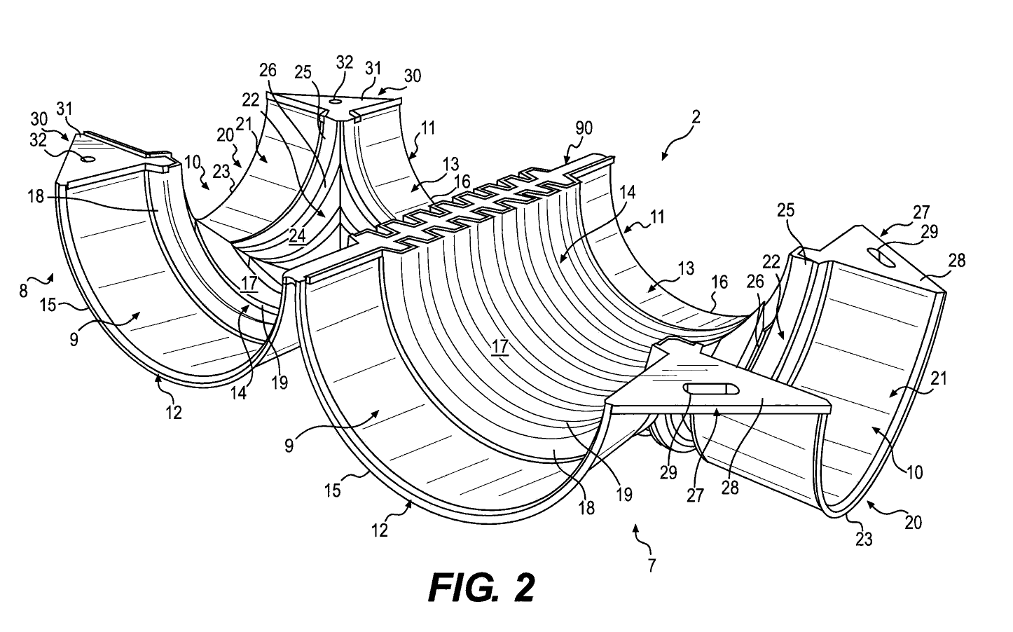

Coupling mechanism 2 may comprise a substantially hollow structure configured to connect together pipes 3, 4, 5. More particularly, coupling mechanism 2 may be configured to transition from an open configuration (e.g., FIGS. 2, 3, and 7) to allow pipes 3, 4, 5 to be positioned within coupling mechanism 2 and a closed configuration (e.g., FIGS. 1, 4, and 5) to secure pipes 3, 4, 5 together. Coupling mechanism 2 may be formed of HDPE, or any other suitable material, such as, for example, PVC or polypropylene. Moreover, although the exemplary embodiments of the present disclosure illustrate coupling mechanism 2 as including a “T-shaped” configuration, it should be appreciated that coupling mechanism 2 may include any other suitable configuration, such as, for example, a “Y-shaped” configuration, an “X-shaped” configuration, a 90° elbow configuration (i.e., an “L-shaped” configuration), and a 45° elbow configuration.

FIG. 2 illustrates a perspective view of coupling mechanism 2 in the open configuration, according to an exemplary embodiment. As shown in FIG. 2, coupling mechanism 2 may include a first portion 7, a second portion 8, and a hinge portion 90 configured to operably engage together first portion 7 and second portion 8. In the open configuration, first portion 7 may be laterally adjacent to second portion 8, with hinge portion 90 positioned between first portion 7 and second portion 8. First portion 7 and second portion 8 may each include a first channel 9 and a second channel 10 substantially perpendicular to first channel 9. It should be appreciated, however, that second channel 10 may extend from first channel 9 at any other angle, such as, for example, a substantially 45° angle for a “Y-shaped” configuration of coupling mechanism 2.

First channel 9 may be defined by a first wall portion 11. As shown in FIG. 2, first wall portion 11 may include a substantially arcuate cross-sectional shape. In certain other embodiments, however, first wall portion 11 may include any other suitable cross-sectional shape depending on, for example, the shape of a pipe disposed in first channel 9. First wall portion 11 may include a first end section 12, a second end section 13, and an intermediate section 14 extending between the first and second end sections 12, 13. First end section 12 may include a first open end face 15, and second end section 13 may include a second open end face 16. First end section 12 and second end section 13 may also each include substantially smooth inner and outer surfaces, and the inner surface may provide a seat onto which a pipe may be positioned. For example, open end 6 of pipe 3 may be positioned on the inner surface of first end section 12, and open end 6 of pipe 5 may be positioned on the inner surface of second end section 13. It should also be appreciated, however, that in certain embodiments, one or both of the inner and outer surfaces of first and second end sections 12, 13 may include bumps, ridges, and corrugations to, for example, facilitate gripping and improved engagement of pipes 3, 5 by first and second end sections 12, 13.

As shown in FIG. 2, intermediate section 14 may include a corrugated wall 17 having a plurality of corrugation crests 18 and corrugation valleys 19. In certain embodiments, corrugated wall 17 may include a dual-wall corrugated section. It should be appreciated that in certain other embodiments, corrugated wall 17 may include a three-wall corrugated section. Moreover, a corrugation crest 18 may be positioned proximate an end of first end section 12 opposite first open end face 15, and a corrugation crest 18 may be positioned proximate an end of second end section 13 opposite second open end face 16. Pipe 3 and pipe 5 disposed in the seats of first and second end sections 12, 13, respectively, may be blocked from advancing into intermediate portion 14, as corrugation crest 18 may abut against open ends 6 of pipe 3 and pipe 5. Accordingly, undesired axial movement of pipes 3, 5 through first channel 9 may be prevented.

Second channel 10 may be defined by a second wall portion 20. As shown in FIG. 2, second wall portion 20 may also include a substantially arcuate cross-sectional shape. In certain other embodiments, however, second wall portion 20 may include any other suitable cross-sectional shape depending on, for example, the shape of a pipe disposed in second channel 10. Second wall portion 20 may include a third end section 21 and a passage section 22. Third end section 21 may include a third open end face 23, and passage section 22 may open into first channel 9. More specifically, passage section 22 may open into intermediate section 14 of first wall portion 11. Third end section 21 may also include a substantially smooth inner and outer surface, and the inner surface may provide a seat onto which a pipe may be positioned. For example, open end 6 of pipe 4 may be positioned on the inner surface of third end section 21. It should also be appreciated, however, that in certain embodiments, one or both of the inner and outer surfaces of third end section 21 may include bumps, ridges, and corrugations to, for example, facilitate gripping and improved engagement of pipe 4 by third end section 21.

Passage section 22 may also include a corrugated wall 24 having a plurality of corrugation crests 25 and corrugation valleys 26. In certain embodiments, corrugated wall 24 may include a dual-wall corrugated section. It should be appreciated, however, that in certain other embodiments, corrugated wall 24 may include a three-wall corrugated section. Furthermore, a corrugation crest 25 may be positioned proximate an end of third end section 21 opposite third open end face 23. Pipe 4 disposed in the seat of third end section 21 may be blocked from advancing into passage section 22, as corrugation crest 25 may abut against open end 6 of pipe 4. Accordingly, undesired axial movement of pipe 4 through second channel 10 and into first channel 9 may be prevented.

Hinge portion 90 may be positioned between first and second portions 7, 8, and may connect together first wall portions 11 of first and second portions 7, 8. Hinge portion 90 may include any suitable mechanism configured to allow first and second portions 7, 8 to move towards each other. First and second portions 7, 8 may pivot at hinge portion 90 and may be folded together such that first wall portions 11 of first and second portions 7, 8 meet and second wall portions 20 of first and second portions 7, 8 meet. In some embodiments, first portion 7 and second portion 8 may be formed of a continuous piece of a single material, and hinge portion 90 may comprise a living hinge formed of the same material as first portion 7 and second portion 8. For example, first portion 7, second portion 8, and hinge portion 90 may be injection molded as a unitary piece of HDPE. In such embodiments, hinge portion 90 may further include a dent or a score between first portion 7 and second portion 8 to facilitate the pivoting of first and second portions 7, 8 about hinge portion 90. In certain other embodiments, however, first portion 7 and second portion 8 may be separate pieces of material joined together by hinge portion 90. In such embodiments, hinge portion 90 may comprise any suitable mechanical hinge configured to effectuate movement between first and second portions 7, 8, including, as examples, a barrel hinge, a pivot hinge, a butt hinge, and the like.

As shown in FIG. 2, hinge portion 90 may allow first portion 7 and second portion 8 to pivot relative to each other such that coupling mechanism 2 may exhibit a low and compact profile in the open configuration. For example, first and second portions 7, 8 may be pivoted at least 180° relative to each other at hinge portion 90 such that the outer surface of first wall portion 11 and the outer surface of second wall portion 20 may contact a flat surface (not shown) supporting coupling mechanism 2. Accordingly, a maximum height of coupling mechanism 2 in the open configuration may be measured from the flat surface up to hinge portion 90.

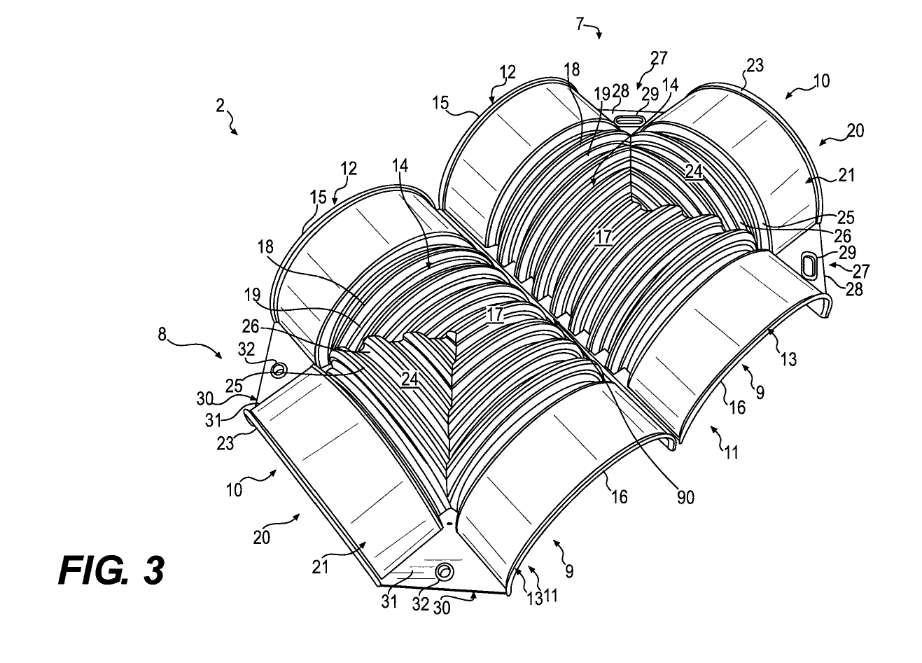

FIG. 3 illustrates another perspective view of coupling mechanism 2, according to an exemplary disclosed embodiment. As shown in FIG. 3, the outer surface of first wall portion 11 may be continuously formed with the outer surface of second wall portion 20. Moreover, corrugation crests 25 and corrugation valleys 26 of second wall portion 20 may be substantially perpendicular to corrugation crests 18 and corrugation valleys 19 of first wall portion 11. More specifically, a number of corrugation crests 25 and corrugation valleys 26 of second wall portion 20 may intersect a number of corrugation crests 18 and corrugation valleys 19 of first wall portion 11. In some embodiments, the outer surfaces of first end section 12 and second end section 13 may be substantially aligned with each corrugation crest 18, and the outer surface of third end section 21 may be substantially aligned with each corrugation crest 25. In certain other embodiments, however, one or more corrugation crests 18 may extend above or below the outer surfaces of first end section 12 and second end section 13, and one or more corrugation crests 25 may extend above or below the outer surface of third end section 21. In addition, corrugation crests 18 of first portion 7 may be substantially aligned with corrugation crests 18 of second portion 8, and corrugation valleys 19 of first portion 7 may be substantially aligned with corrugation valleys 19 of second portion 8. In certain other embodiments, corrugation crests 18 of first portion 7 and corrugation crests 18 of second portion 8 may be substantially staggered relative to each other, and corrugation valleys 19 of first portion 7 and corrugation valleys 19 of second portion 8 may be substantially staggered relative to each other.

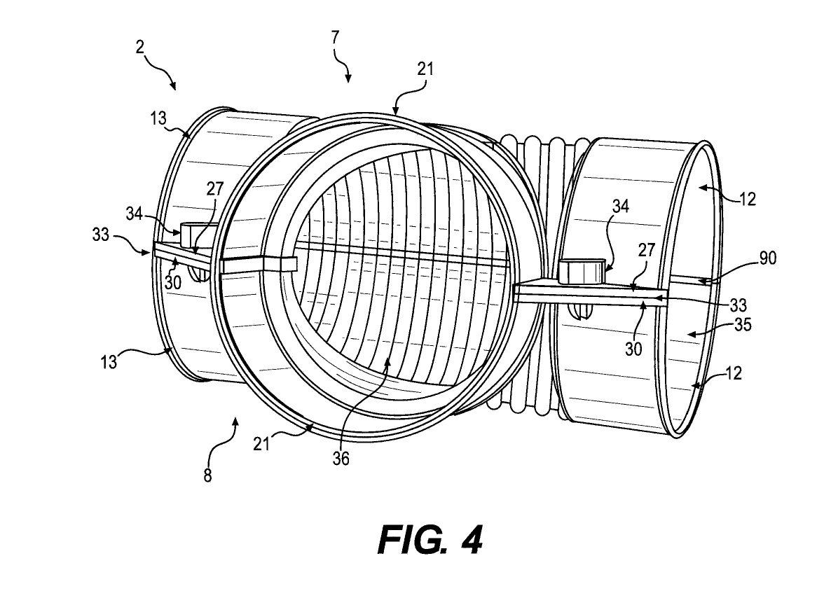

As shown in FIGS. 2 and 3, first portion 7 may include first locking interfaces 27 positioned on lateral sides of second channel 10. Each first locking interface 27 may include a first plate 28 integrally formed (e.g., injected molded) with first wall portion 11 and second wall portion 20 of first portion 7. First plate 28 may include a first aperture 29 defined on a substantially central location of first plate 28. Similar to first portion 7, second portion 8 may include second locking interfaces 30. Each second locking interface 30 may include a second plate 31 integrally formed (e.g., injected molded) with first wall portion 11 and second wall portion 20 of second portion 8, and may include a second aperture 32 defined on a substantially central location of second plate 31. Second aperture 32 may include a diameter smaller than a diameter of first aperture 29. As will be discussed in more detail below, when first portion 7 and second portion 8 are in the closed configuration, first locking interfaces 27 may engage with corresponding second locking interfaces 30, substantially aligning first apertures 29 and second apertures 32, and forming lock mechanisms 33 configured to hold together first portion 7 and second portion 8 by mating with key mechanisms 34 (FIGS. 4-6).

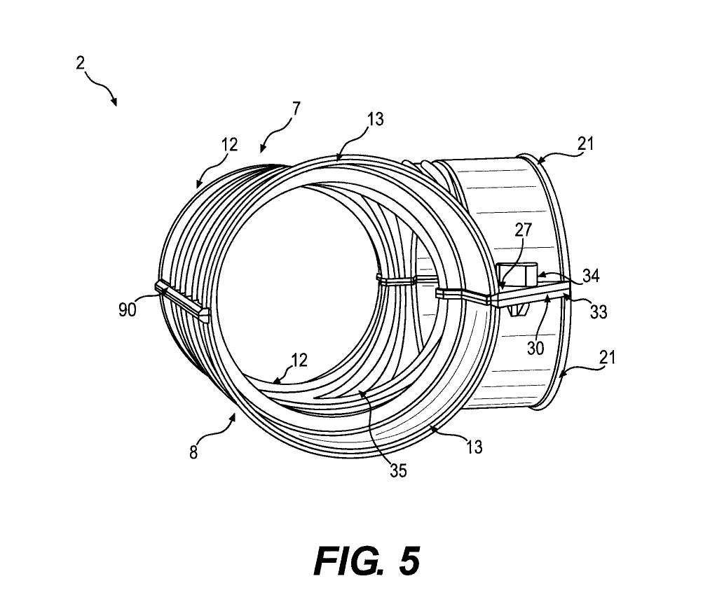

FIGS. 4-5 illustrate perspective views of coupling mechanism 2 in the closed configuration, according to an exemplary disclosed embodiment. To transition coupling mechanism 2 from the open configuration to the closed configuration, first portion 7 and second portion 8 may be folded together by pivoting first portion 7 and second portion 8 relative to each other about hinge portion 90. In the closed configuration, first end section 12, second end section 13, and third end section 21 of first portion 7 may engage first end section 12, second end section 13, and third end section 21 of second portion 8, respectively.

First channel 9 of first portion 7 and first channel 9 of second portion 8 may be enclosed by first end sections 12, intermediate sections 14, and second end sections 13 of first and second portions 7, 8 to form a first lumen 35. First lumen 35 may axially extend from first end sections 12 to second end sections 13. Moreover, second channel 10 of first portion 7 and second channel 10 of second portion 8 may be enclosed by third end sections 21 and passage sections 22 of first and second portions 7, 8 to form a second lumen 36. Second lumen 36 may axially extend from third end sections 21 and into first lumen 35. First lumen 35 and second lumen 36 both may be fluid-tight.

With reference to FIGS. 1, 4, 5, and 7, coupling mechanism 2 may fluidly connect together first pipe 3, second pipe 4, and third pipe 5 in the closed configuration. More specifically, first end sections 12 of first and second portions 7, 8 may encase open end 6 of third pipe 5 and form a fluid-tight interface between third pipe 5 and coupling mechanism 2. In certain embodiments, a sealing mechanism, such as, for example, a gasket or an O-ring, may be disposed around an outer surface of third pipe 5 engaging first end sections 12 to facilitate a fluid-tight seal between third pipe 5 and first end sections 12. The inner surfaces of first end sections 12 may contact and grasp third pipe 5 (or the sealing mechanism disposed around third pipe 5) to also restrict axial movement of third pipe 5 relative to first lumen 35. In a similar manner, second end sections 13 of first and second portions 7, 8 may encase open end 6 of first pipe 3 and form a fluid-tight interface between first pipe 3 and coupling mechanism 2. A suitable sealing mechanism may also be disposed around an outer surface of first pipe 3 engaging second end sections 13 to facilitate a fluid-tight seal between first pipe 3 and second end sections 13, and the inner surfaces of second end sections 13 may contact and grasp first pipe 3 (or the sealing mechanism disposed around first pipe 3) to restrict axial movement of first pipe 3 relative to first lumen 35. Third end sections 21 of first and second portions 7, 8 may encase open end 6 of second pipe 4 and form a fluid-tight interface between second pipe 4 and coupling mechanism 2. A suitable sealing mechanism may also be disposed around an outer surface of second pipe 4 engaging third end sections 21 to facilitate a fluid-tight seal between second pipe 4 and third end sections 21, and the inner surfaces of third end sections 21 may contact and grasp second pipe 4 (or the sealing mechanism disposed around second pipe 4) to restrict axial movement of second pipe 4 relative to second lumen 36. By connecting and securing first pipe 3, second pipe 4, and third pipe 5 to coupling mechanism 2, first pipe 3, second pipe 4, and third pipe 5 may be in fluid communication with each other. For example, fluid may be delivered to and/or transported from second pipe 4 through second lumen 36, and fluid may be delivered to and/or transported from one or both of first pipe 3 and second pipe 4 through first lumen 35.

In certain embodiments, coupling mechanism 2 may be configured to accommodate the coupling of various sized pipes. For example, coupling mechanism 2 may be configured to increase the diameter of first lumen 35 and second lumen 36 to provide access and engagement of pipes having larger diameters than, for example, pipes 3, 4, 5. In such embodiments, hinge portion 90 may be configured to extend such that a distance between first portion 7 and second portion 8 at hinge portion 90 may be increased. Hinge portion 90 may comprise, for example, collapsible bellows and/or a resilient material, to allow hinge portion 90 to extend and collapse. Accordingly, first end sections 12, second end sections 13, and/or third end sections 21 may engage the outer surfaces of one or more larger pipes with hinge portion 90 extended to accommodate the larger pipes.

As alluded to above, key mechanisms 34 may be configured to engage with lock mechanisms 33 to secure together first portion 7 and second portion 8 in the closed configuration. With reference to FIGS. 4 and 5, each lock mechanism 33 may include first locking interface 27 engaged with second locking interface 30. That is, each lock mechanism 33 may include first plate 28 contacting second plate 31, with first aperture 29 substantially aligned with second aperture 32. Key mechanism 34 may be inserted through first and second apertures 29, 32 and may form a snap fit with lock mechanism 33 to secure together first and second locking interfaces 27, 30, and thus, first and second portions 7, 8.

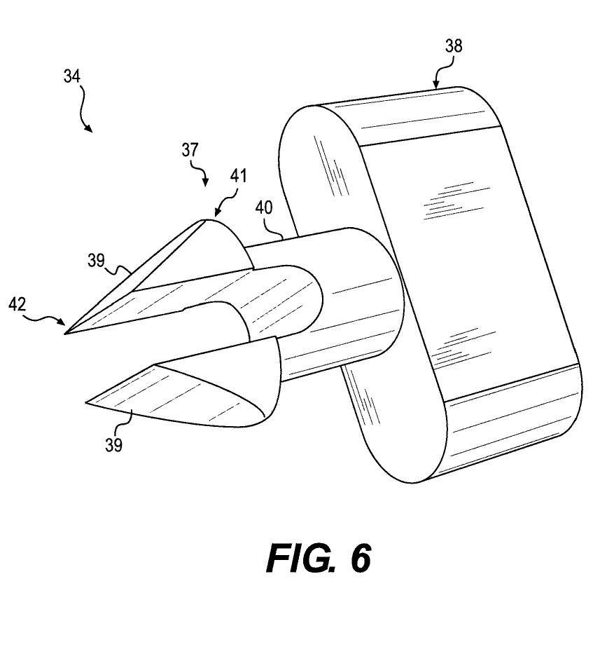

FIG. 6 illustrates a perspective view of key mechanism 34, according to an exemplary disclosed embodiment. Key mechanism 34 may include an insert portion 37 and a stop portion 38. Insert portion 37 may be configured to be delivered through first and second apertures 29, 32 (FIGS. 1-3), and may include a set of prongs 39 integrally formed with a stem 40. Stem 40 may in turn be integrally formed with, or otherwise suitably attached to, stop portion 38. Prongs 39 may include a tapered configuration, wherein a width measured between the outer surfaces of each prong 39 decreases from a first end 41 to a second end 42. In addition, key mechanism 34 may be formed of a generally resilient material, such as, for example, HDPE or PVC. As such, prongs 39 may be configured to bend towards each other, and may be biased to separate from each other. In a biased configuration (e.g., as shown in FIG. 6), a width of prongs 39 at first end 41 may be larger than a diameter of second aperture 32 but appropriately sized to fit through first aperture 29, and a width of prongs 39 at second end 42 may be appropriately sized to fit through both first aperture 29 and second aperture 32. When prongs 39 are bent towards each other, the width of prongs 39 at first end 41 may be appropriately sized to fit through both first aperture 29 and second aperture 32. Moreover, a diameter of stem 40 may be appropriately sized to fit through both first aperture 29 and second aperture 32. Stop portion 38 may be appropriately sized and shaped for an operator to grab key mechanism 34 and drive insert portion 37 through lock mechanism 33 and to prevent stop portion 38 from entering first and second apertures 29, 32.

As insert portion 37 is delivered through first and second apertures 29, 32, prongs 39 may abut against the walls defining second aperture 32 and may bend towards each other, allowing first end 41 of prongs 39 to fit through second aperture 32. Once completely through second aperture 32, prongs 39 may return to their biased configuration, and first end 41 of prongs 39 may prevent insert portion 37 from being dislodged through second aperture 32, and thus, securing together first and second portions 7, 8. As shown in FIGS. 4 and 5, stop portion 38 may be disposed on first locking interface 27, and may be prevented from advancing through first and second apertures 29, 32. Key mechanism 34 may also allow the engagement between first and second portions 7, 8 to be released. The operator may bend prongs 39 toward each other and advance prongs 39 and insert portion 37 through second aperture 32 and first aperture 29 to disengage key mechanism 34 from lock mechanism 33.

Although the present disclosure describes the engagement of key mechanisms 34 and lock mechanisms 33 to secure together first and second portions 7, 8, it should be appreciated that any other appropriate securing apparatuses may be employed. For example, suitable fasteners, locks, snaps, brackets, and the like may be utilized to releasably secure together first and second portions 7, 8.

FIG. 7 illustrates a perspective view of pipe system 1 with pipes 3, 4, 5 disposed in coupling mechanism 2 in the open configuration. More particularly, third pipe 5 may be positioned on the inner surface of first end section 12 of second portion 8, second pipe 4 may be positioned on the inner surface of third end section 21 of second portion 8, and first pipe 3 may be positioned on the inner surface of second end section 13 of second portion 8. First portion 7 may then be pivoted about hinge portion 90 and folded over pipes 3, 4, 5 and placed in the closed configuration (FIGS. 1, 4, and 5). The inner surfaces of first end sections 12 may engage and secure third pipe 5, the inner surfaces of third end sections 21 may engage and secure second pipe 4, and the inner surfaces of second end sections 13 may engage and secure first pipe 3, with first and third pipes 3, 5 disposed in first lumen 35 and second pipe 4 disposed in second lumen 36. Key mechanisms 34 may then be inserted through lock mechanisms 33 to secure together first portion 7 and second portion 8. It should also be appreciated that pipes 3, 4, 5 may be positioned in first portion 7, and second portion 8 may be folded over pipes 3, 4, 5 and secured to first portion 7.

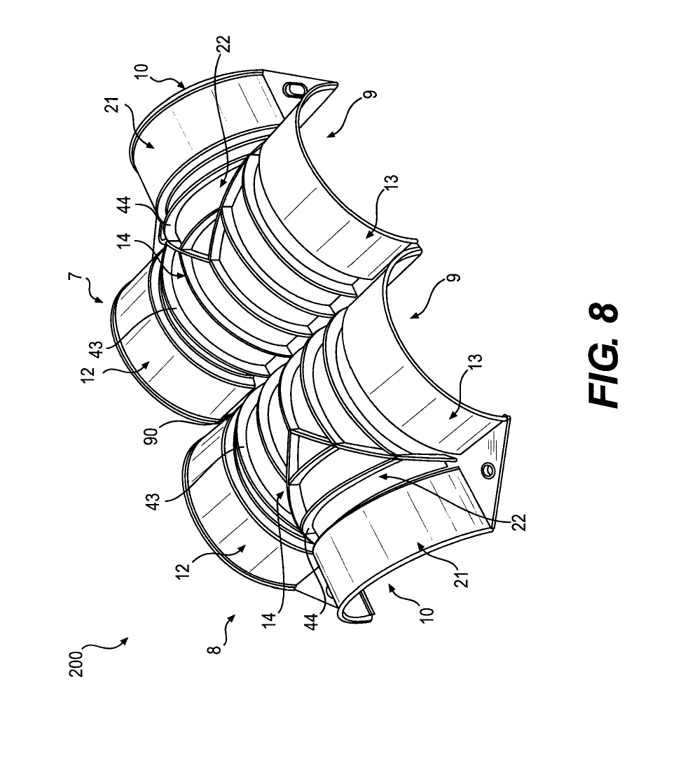

FIG. 8 illustrates a perspective view of another coupling mechanism 200 in an open configuration, according to an exemplary embodiment. Coupling mechanism 200 may include substantially similar features and applications as coupling mechanism 2 discussed above. Coupling mechanism 200, however, may include a ribbed configuration. An outer surface of first portion 7 and an outer surface of second portion 8 may include a first plurality of ribs 43 and a second plurality of ribs 44 arranged substantially perpendicular to first plurality of ribs 43. First plurality of ribs 43 may extend between first and second end sections 12, 13. Second plurality of ribs 44 may extend from third end sections 21 and towards hinge portion 90, intersecting with first plurality of ribs 43. The inner surfaces defining first channels 9 and second channels 10 may be substantially smooth. In addition, a diameter defined by the inner surface along intermediate section 14 may be smaller than a diameter defined by the inner surface along first end section 12 and a diameter defined by the inner surface along second end section 13. A diameter defined by the inner surface along passage sections 22 may be smaller than a diameter defined by the inner surface along third end sections 21. Accordingly, the inner surface of intermediate sections 14 may provide an appropriate stop to prevent first pipe 3 and third pipe 5 from axially advancing into a portion of first channels 9 defined by intermediate sections 14, and the inner surfaces of passage sections 22 may provide an appropriate stop to prevent second pipe 4 from axially advancing into portions of second channels 10 defined by passage sections 22.

Similar to corrugation crests 18, each first rib 43 may be substantially aligned with the outer surface of each first end section 12 and the outer surface of each second end section 13, and similar to corrugation crests 25, each second rib 44 may be substantially aligned with the outer surface of each third end section 21.

Coupling mechanisms 2, 200 may provide a number of features. For example, coupling mechanisms 2, 200 may ease the installation of pipes 3, 4, 5 together. Pipes 3, 4, 5 may simply be positioned within one of first portion 7 and second portion 8 of coupling mechanisms 2, 200, and the other of first portion 7 and second portion 8 may be folded over pipes 3, 4, 5 by pivoting about hinge portion 90 to secure and fluidly couple together pipes 3, 4, 5. Coupling mechanisms 2, 200 may obviate the need to push and/or compress pipes 3, 4, 5 to insert open ends 6 of pipes 3, 4, 5 into coupling mechanisms 2, 200. Moreover, less length of pipe 3, 4, 5 may be utilized to adequately secure pipes 3, 4, 5 to coupling mechanisms 2, 200. For example, a length of pipe 3 merely extending along the length of first end sections 12 may be utilized to secure pipe 3 to coupling mechanisms 2, 200, a length of pipe 4 merely extending along the length of third end sections 21 may be utilized to secure pipe 4 to coupling mechanisms 2, 200, and a length of pipe 5 merely extending along the length of second end sections 13 may be utilized to secure pipe 5 to coupling mechanisms 2, 200. As such, connecting together existing piping may be simplified. For instance, in applications with existing underground piping, an area large enough to position coupling mechanisms 2, 200 under the existing pipes may be unearthed, as opposed to unearthing a larger area to expose enough length of piping to be pushed and/or compressed into known coupling mechanisms. The pipes may then be cut to form open ends, and the open ends may be connected to coupling mechanisms 2, 200.

In addition, coupling mechanisms 2, 200 may provide the ability to connect together a variety of different sized pipes. Because hinge portion 90 may be configured to extend and collapse to increase and decrease the diameters of first lumen 35 and second lumen 36, coupling mechanism 2, 200 may be configured to accommodate larger and smaller sized pipes. In addition, coupling mechanisms 2, 200 may also provide the ability to connect together different types of pipes, such as, for example, corrugated, smooth, ribbed, and the like, as first end sections 12, second end sections 13, and third end sections 21 may be folded together to clamp the outer surfaces of the pipes.

Moreover, the low profile of coupling mechanisms 2, 200 in the open configurations (FIGS. 2, 3, and 8) may improve storage and shipping applications. In the open configuration, coupling mechanisms 2, 200 may be stacked on top of each other such that the inner surface of first wall portion 11 and the inner surface of second wall portion 20 of one coupling mechanism 2, 200 may be positioned on top of and encase the respective outer surface of first wall portion 11 and outer surface of second wall portion 20 of another coupling mechanism 2, 200. Stacking multiple coupling mechanisms 2, 200 may minimize the amount of space taken up by the coupling mechanisms 2, 200. Therefore, a greater number of coupling mechanisms 2, 200 may be shipped and stored, while occupying a smaller volume of space.

Any aspect set forth in any embodiment may be used with any other embodiment set forth herein. Furthermore, it will be apparent to those skilled in the art that various modifications and variations can be made in the disclosed systems and processes without departing from the scope of the disclosure. Other embodiments of the invention will be apparent to those skilled in the art from consideration of the specification and practice of the invention disclosed herein. It is intended that the specification and examples be considered as exemplary only. The following disclosure identifies some other exemplary embodiments.

1. A coupling mechanism for connecting together a plurality of pipes, the coupling mechanism comprising:
a first portion including a first wall having a substantially arcuate cross-sectional shape and defining a first channel;
a second portion including a second wall having a substantially arcuate cross-sectional shape and defining a second channel; and
a hinge portion connecting together the first portion and the second portion, wherein the first portion and the second portion are configured to pivot about the hinge portion;
wherein, in an open configuration of the coupling mechanism, the first portion is laterally adjacent to the second portion,
and in a closed configuration of the coupling mechanism, the first portion and the second portion are folded together about the hinge portion to form a first lumen encased by the first wall and the second wall, wherein the first lumen includes a first end section having a first substantially smooth inner surface, a second end section having a second substantially smooth inner surface, and an intermediate section positioned between the first end section and the second end section, wherein the intermediate section is configured to prevent advancement of a first pipe positioned in the first end section and a second pipe positioned in the second end section.

2. The coupling mechanism of claim 1, wherein the first portion includes a third wall having a substantially arcuate cross-sectional shape and defines a third channel, and the second portion includes a fourth wall having a substantially arcuate cross-sectional shape and defines a fourth channel.

3. The coupling mechanism of claim 2, wherein, in the closed configuration of the coupling mechanism, the first portion and the second portion are folded together to form a second lumen encased by the third wall and the fourth wall.

4. The coupling mechanism of claim 3, wherein the second lumen is substantially perpendicular to the first lumen.

5. The coupling mechanism of claim 1, wherein the first wall includes a first corrugated section having a first plurality of corrugation peaks and a first plurality of corrugation valleys, and the second wall includes a second corrugated section having a second plurality of corrugation peaks and a second plurality of corrugation valleys.

6. The coupling mechanism of claim 3, wherein the first wall includes a first corrugated section having a first plurality of corrugation peaks and a first plurality of corrugation valleys, the second wall includes a second corrugated section having a second plurality of corrugation peaks and a second plurality of corrugation valleys, the third wall includes a third corrugated section having a third plurality of corrugation peaks and a third plurality of corrugation valleys, and the fourth wall includes a fourth corrugated section having a fourth plurality of corrugation peaks and a fourth plurality of corrugation valleys.

7. The coupling mechanism of claim 6, wherein the first plurality of corrugation peaks and the first plurality of corrugation valleys are substantially perpendicular to the third plurality of corrugation peaks and the third plurality of corrugation valleys, and the second plurality of corrugation peaks and the second plurality of corrugation valleys are substantially perpendicular to the fourth plurality of corrugation peaks and the fourth plurality of corrugation valleys.

8. The coupling mechanism of claim 1, wherein the first wall includes a first ribbed section having a first plurality of ribs, and the second wall includes a second ribbed section having a second plurality of ribs.

9. The coupling mechanism of claim 8, wherein an entirety of an inner surface of the first wall and the second wall, which define the first lumen, is substantially smooth.

10. The coupling mechanism of claim 1, wherein the first portion, the second portion, and the hinge portion are formed of a continuous piece of a single material.

11-12. (canceled)

13. The coupling mechanism of claim 1, further comprising a lock mechanism coupled to the first portion and the second portion and a key mechanism, wherein the key mechanism is configured to engage with the lock mechanism to secure together the first portion and the second portion in the closed configuration.

14. A method for connecting together a plurality of pipes, the method comprising:
positioning a coupling mechanism in an open configuration, the coupling mechanism including:
a first portion including a first wall having a substantially arcuate cross-sectional shape and defining a first channel;
a second portion including a second wall having a substantially arcuate cross-sectional shape and defining a second channel; and
a hinge portion connecting together the first portion and the second portion, wherein the first portion and the second portion are configured to pivot about the hinge portion;
wherein, in the open configuration, the first portion is laterally adjacent to the second portion;
positioning a first pipe in the first channel of the first portion at a first end of the first channel;
positioning a second pipe in the first channel of the first portion at a second end of the first channel opposite the first end; and
folding together the first portion and the second portion about the hinge portion to encase the first pipe within a first end section defined by the first wall and the second wall and encase the second pipe within a second end section defined by the first wall and the second wall, wherein the first end section includes a first substantially smooth inner surface, and the second end section includes a second substantially smooth inner surface, wherein an intermediate section is positioned between the first end section and the second end section and is configured to prevent advancement of the first pipe positioned in the first end section and the second pipe positioned in the second end section.

15. The method of claim 14, further comprising forming a first fluid-tight seal between the first pipe and the first wall and the second wall, and forming a second fluid-tight seal between the second pipe and the first wall and the second wall.

16. The method of claim 14, wherein the coupling mechanism includes a lock mechanism coupled to the first portion and the second portion.

17. The method of claim 16, further comprising securing together the first portion and the second portion by engaging a key mechanism with the lock mechanism.

18. A pipe system, comprising:
a plurality of pipes; and
a coupling mechanism configured to fluidly connect together the plurality of pipes, the coupling mechanism including:
a first portion including a first wall having a substantially arcuate cross-sectional shape and defining a first channel;
a second portion including a second wall having a substantially arcuate cross-sectional shape and defining a second channel;
a hinge portion connecting together the first portion and the second portion, wherein the first portion and the second portion are configured to pivot about the hinge portion; and
a lock mechanism coupled to the first portion and the second portion;
wherein the first portion and the second portion are folded together about the hinge portion to encase open ends of the plurality of pipes within a first end section and a second end section defined by the first wall and the second wall, wherein the first end section includes a first substantial smooth inner surface, and the second end section includes a second substantially smooth inner surface, wherein an intermediate section is positioned between the first end section and the second end section and is configured to prevent advancement of the plurality of pipes encased within the first and second end sections;
wherein a key mechanism is engaged with the lock mechanism to secure together the first portion and the second portion.

19. The pipe system of claim 18, wherein the first wall of the coupling mechanism includes a first corrugated section including a first plurality of corrugation peaks and a first plurality of corrugation valleys, and the second wall of the coupling mechanism includes a second corrugated section including a second plurality of corrugation peaks and a second plurality of corrugation valleys.

20. (canceled)

21. The pipe system of claim 5, wherein the intermediate section is defined by the first corrugated section and the second corrugated section.

22. The pipe system of claim 21, wherein a first corrugation positioned proximate the first end section is configured to block advancement of the first pipe positioned in the first end section, and a second corrugation positioned proximate the second end section is configured to block advancement of the second pipe positioned in the second end section.

23. The pipe system of claim 1, wherein the intermediate section includes a diameter smaller than a diameter of the first end section and a diameter of the second end section.
